(19) United States
(12) Patent Application Publication
(10) Pub. No.: US 2022/0190408 A1
(43) Pub. Date: Jun. 16, 2022

(54) SYSTEM AND METHOD FOR HYBRID POWER BACKUP USING GRAPHENE BASED METAL AIR BATTERY

(71) Applicant: LOG 9 MATERIALS SCIENTIFIC PRIVATE LIMITED, BENGALURU (IN)

(72) Inventors: AKSHAY VIVEK SINGHAL, DEOBAND (IN); ANSHUL KUMAR SHARMA, KANGRA (IN); ANKUSH RAINA, JAMMU TAWI (IN); HEMANT CHARAYA, HISAR (IN); ANUJ JAIN, ROHTAK (IN)

(21) Appl. No.: 17/347,530

(22) PCT Filed: Dec. 16, 2019
(86) PCT No.: PCT/IN2019/050925

§ 371 Date: Jun. 14, 2021

(30) Foreign Application Priority Data
Dec. 15, 2018 (IN) 201811043053

(51) Int. Cl. H01M 12/06; H01M 4/46; H01M 4/96; H02J 7/00

(52) U.S. Cl. CPC H01M 12/06; H01M 4/463; H01M 2220/10; H02J 7/0048; H01M 4/96

(57) ABSTRACT

The embodiments herein disclose a power backup system comprising a graphene-based metal-air battery (GMAB), and at least one auxiliary power source as a secondary and additional back-up. The GMAB comprises an electrolyte reservoir for storing electrolyte; a pump for pumping the electrolyte to a plurality of cells; a filter, coupled to the pump, for entrapping aluminum oxide particles generated by electrolyte flow through the cells, to free the electrolyte from any metal oxide particle impurities; at least one rotameter coupled to the pump; at least one settling tank to remove metal oxide particles from the electrolyte; at least one buffer tank to replenish the electrolyte to a desired composition; and a mechanical refuelling unit for mechanical retraction of consumed aluminum and insertion of a plurality of fresh aluminum cassettes into the cells simultaneously.

### CROSS-REFERENCE TO RELATED APPLICATIONS

The present application is a National Phase Application of the PCT application with the serial number PCT/IN2019/050925 filed on Dec. 16, 2019 with the title, “SYSTEM AND METHOD FOR HYBRID POWER BACKUP USING GRAPHENE BASED METAL-AIR BATTERY”. The embodiments herein claim the priority of the Indian Provisional Patent Application with serial number 201811043053, filed on Nov. 15, 2018 and subsequently post dated by 1 Month to Dec. 15, 2018 with the file, “SYSTEM AND METHOD FOR HYBRID POWER BACKUP USING GRAPHENE BASED METAL-AIR BATTERY”, and the contents of which are included in entirety as reference herein.

### BACKGROUND

### Technical Field

The embodiments herein are generally related to a field of fuel cells and batteries. The embodiments herein are particularly related to a system and method for energy storage and power backup for an uninterrupted power supply. The embodiments herein are more particularly related to a system and method for energy storage and hybrid power backups using graphene-based metal-air batteries.

### Description of the Related Art

From industries and businesses that involve sophisticated high-tech machinery and equipment, to public service institutions, such as hospitals, sewage treatment plants, telecommunications and households that are situated in locations with harsh environmental conditions, all installations require power systems that are high in stability, reliability, quality and availability. As the world continues to witness a rapid economic development and digitization, the demand for this continuous and uninterrupted power supply has been swiftly increasing.

Conventional electricity grids regularly suffer from continuous voltage fluctuations, complete power failures due to natural occurrences and short-term power outages. Hence, it is essential to have power backup systems in place, for an uninterrupted power supply, that is called upon when any situation arises. Moreover, there are various remote areas over the world, with no infrastructure developed for power generation, where these power backups can be transported to provide electricity.

Power backup systems based on diesel generators and lead acid batteries are still very common and mostly used. However, in the wake of global warming and advancement in battery technology, Li-ion batteries are now-a-days a preferable choice for power backups systems, and their large-scale commercialization has also helped in realizing this transformation. Though Li-ion batteries provide a cleaner and eco-friendly option to power backups, but their low energy density requires many battery cells to be connected to fulfill substantial energy requirements. This results in further requirement of large spaces to place these setups and difficulty in their relocation. Moreover, the fact that Li-ion batteries are already approaching their theoretical energy density values and further require an availability of grid power for charging, does not help the cause either. So there is an urgent need to look for some other alternatives.

Hence there is a need for a stationary power backup system using a graphene-based metal-air battery (GMAB). Further there is a need for a power backup system using a graphene-based metal-air battery (GMAB) and one auxiliary power source. Yet there is a need for a power backup system using a graphene-based metal-air battery (GMAB) and two or more auxiliary power sources.

The above short comings, disadvantages and problems are addressed herein, which will be understood by studying the following specifications.

### OBJECTIVES OF THE EMBODIMENTS

The primary objective of the embodiments herein is to provide a stationary power backup system using a graphene-based metal-air battery (GMAB).

Another object of the embodiments herein is to develop a power backup system comprising one primary metal-air battery such as Aluminium-Air battery, Zinc-Air battery, Lithium-air battery, Iron-air battery etc.

Yet another object of the embodiments herein is to develop a power backup system with the primary metal-air battery comprising a plurality cells in the range of 10-20000 and are arranged in series or in parallel or a combination thereof.

Yet another object of the embodiments herein is to develop a power backup system in which the primary metal-air battery cells are arranged in a single or multiple floor level.

Yet another object of the embodiments herein is to develop a power backup system comprising two or more auxiliary power sources selected from a group consisting of metal-ion battery, lead acid battery, Ni—Cd battery, redox flow battery, supercapacitors and nickel metal hydride battery.

Yet another object of the embodiments herein is to develop a power backup system comprising an inverter for converting a generated DC power to AC power to run the electrical appliances/load.

Yet another object of the embodiments herein is to develop a power backup system that is capable of delivering power for a short duration of time through the auxiliary power sources without prompting an operation of primary metal-air battery.

Yet another object of the embodiments herein is to develop a power backup system comprising an electronic circuit to allow a dynamic/manual switching between the auxiliary power sources.

Yet another object of the embodiments herein is to develop a power backup system in which, one or more auxiliary power sources are configured to deliver power to the inverter at any time, during an operation of the power backup system.

Yet another object of the embodiments herein is to develop a power backup system in which, one or more of auxiliary power sources are charged by the primary metal-air battery at any time, during an operation of the power backup system.

Yet another object of the embodiments herein is to develop a power backup system in which the primary metal-air battery and the auxiliary power sources are electrically connected through diodes and transistors that are used for an efficient current collection.

Yet another object of the embodiments herein is to develop a power backup system with a monitoring system comprising one or more feedback sensors to regulate a temperature, flow, power and energy of an overall system.

Yet another object of the embodiments herein is to develop a power backup system with a display panel for showing a real time data acquired from the feedback sensors.

Yet another object of the embodiments herein is to develop a power backup system with a monitoring system loaded with an algorithm to accurately estimate a real-time state of charge (SoC) of the auxiliary power sources.

Yet another object of the embodiments herein is to develop a power backup system with a flow management system to regulate a circulation of electrolyte inside the cells of the primary metal-air battery.

Yet another object of the embodiments herein is to develop a power backup system with a flow management system comprising one or more pumps for pumping electrolyte inside the cells of primary metal-air battery.

Yet another object of the embodiments herein is to develop a power backup system with a flow management system comprising one or more rotameters in the range of 1-1000 lpm, and integrated with gate valves, solenoid valves and screw valves, to facilitate a uniform distribution of electrolyte.

Yet another object of the embodiments herein is to develop a power backup system with a flow management system comprising one or more distributors for a controlled and systematic distribution of electrolyte across a plurality of cells on each floor.

Yet another object of the embodiments herein is to develop a power backup system with a flow management system comprising a leakage/over flow management system to drain/wash out a spilled electrolyte on each floor.

Yet another object of the embodiments herein is to develop a power backup system comprising an electrolyte management system to maintain temperature of the electrolyte in the range of 10-80° C. and to carry out a purification of the electrolyte.

Yet another object of the embodiments herein is to develop a power backup system with a heating-cooling system/setup comprising a resistive heater, inductive heater, radiator, fan or coolant circulation system or a combination thereof.

Yet another object of the embodiments herein is to develop a power backup system with an electrolyte management system comprising a series of screen filters, disc filters, graphene-based filters or a combination thereof, for purifying electrolyte by collecting an incoming sludge formed during an operation of metal-air battery.

Yet another object of the embodiments herein is to develop a power backup system comprising a hybrid system for collecting hydrogen gas produced during an operation of primary metal-air battery.

Yet another object of the embodiments herein is to develop a power backup system with a hybrid system comprising a hydrogen fuel cell which runs on the collected hydrogen gas that helps/aids in contributing power energy output.

Yet another object of the embodiments herein is to develop a power backup system comprising an exhaust setup/system to remove any type of fumes and gases generated during the operation.

Yet another object of the embodiments herein is to develop a power backup system comprising only one auxiliary power source so that the load is directly run with GMAB, when only one auxiliary power source is used, and the auxiliary power source is additionally used to meet that power requirement, when the required power is more than that is supplied from GMAB, and the additional power than that supplied from GMAB to the load is used to charge the auxiliary power source, when the required power for load is less than the power generated at GMAB.

These and other aspects of the embodiments herein will be better appreciated and understood when considered in conjunction with the following description and the accompanying drawings. It should be understood, however, that the following descriptions, while indicating embodiments and numerous specific details thereof, are given by way of illustration and not of limitation. Many changes and modifications may be made within the scope of the embodiments herein without departing from the scope and spirit thereof, and the embodiments herein include all such modifications.

### SUMMARY

This summary is provided to introduce a selection of concepts in a simplified form that are further disclosed in the detailed description. This summary is not intended to determine the scope of the claimed subject matter.

The various embodiments herein provide a stationary power backup system using a graphene-based metal-air battery for supplying electrical power to domestic electrical appliances and heavy machinery in industries, to vital services such as hospitals and telecommunication towers and to supply power in remote areas.

The various embodiments herein provide a stationary power backup system comprising a main power source, one or more auxiliary power source, an electrolyte flow management system, electrolyte characteristics management system, a real-time monitoring system, electronic power control system, and Hydrogen Harvesting/Collection System.

According to one embodiment herein, a main power source is graphene-based metal-air battery (GMAB). The main power source in this system generates electrical energy to supply electrical power to the external load. The GMAB comprises a reservoir containing an electrolyte of alkaline nature. The electrolyte is passed through a stack (plurality) of cells that are electrically connected with one another in series or parallel or a combination thereof. Only when the cells are filled with the electrolyte, a reaction is initiated at the anode and the cathode. The metallic particle at the anode is converted into a metal oxide. The oxygen from the ambient air is diffused through the air cathode and is reduced to the OH ions. As a result, an electrical power is generated. The reaction is most efficient, only when the temperature of the electrolyte is with in a pre-set range or threshold level.

According to one embodiment herein, the one or more primary metal-air battery is selected from a group consisting of Aluminium-Air battery, Zinc-Air battery, Lithium-air battery, and Iron-air battery.

According to one embodiment herein, the primary metal-air battery comprises of a plurality of cells and wherein the plurality of cells is in the range of 10-20000.

According to one embodiment herein, the primary metal-air battery cells are arranged in one or more floors (single or multiple floors). The cells on the one or more floors (same or different floors) are electrically connected in series or parallel or a combination thereof.

According to one embodiment herein, an electrolyte characteristic management system is provided to maintain a temperature of the electrolyte within a desired limit or pre-set range or threshold level through a heating-cooling mechanism/system.

According to one embodiment herein, the electrolyte characteristic management system further comprises a plurality of filter cartridges to entrap/capture the aluminum oxide particles that are generated as by-product of the electrolytic reaction with anode and cathode, and are collected from the cells with the electrolyte flow. The filter cartridges are configured to free the electrolyte from any metal oxide particle impurities that interferes in a reaction process with anode and cathode.

According to one embodiment herein, the electrolyte characteristic management system further comprises a plurality of settling tanks for removing metal oxide particles from the electrolyte. According to an embodiment herein, the plurality of settling tanks is a plurality of electrolyte reservoir tanks. The metal oxide particles removed from the electrolyte are made to settle down at the bottom of each tank through gravity forces either naturally or forcefully by chemically induced coagulation process. The coagulation process is performed to increase the size of the particles and to promote a quick/faster settling of metal oxide particles.

According to one embodiment herein, the electrolyte characteristic management system further comprises a plurality of buffer tanks to maintain the electrolyte at desired composition. The electrolyte characteristic management system is configured to regularly monitor the concentrations of all the components present in the electrolyte. The buffer tanks are provided to replenish the electrolyte to the desired composition.

According to one embodiment herein, the electrolyte characteristic management system is configured to maintain an electrolyte temperature in the range of 10-80° C. and also carry out continuous purification of the electrolyte.

According to one embodiment herein, the heating-cooling system comprises one or more combinations of a resistive heater, an inductive heater, a radiator, a fan or coolant circulation system.

According to one embodiment herein, the electrolyte characteristic management system comprises the plurality of filter cartridges selected from a group consisting of a series of screen filters, disc filters, graphene-based filters or plurality of these for the continuous purification of incoming electrolyte by collecting the sludge formed during the operation of metal-air battery.

According to one embodiment herein, a refuelling mechanism is provided to mechanically refuel GMAB. The refuelling mechanism is configured to mechanically retract the consumed aluminum and to insert of a plurality of fresh aluminum cassettes into the cells in a single time.

According to one embodiment herein, an electrolyte flow management system is provided to regulate a circulation of electrolyte through the cells of the primary metal-air battery module.

According to one embodiment herein, the electrolyte flow management system comprises one or more pumps for pumping the electrolyte inside the cells of primary metal-air battery. The one or more pumps is selected from a group consisting of a diaphragm pump, a submersible pump, a centrifugal pump, a positive displacement pump, a hydraulic pump and a combination thereof.

According to one embodiment herein, the electrolyte flow management system comprises one or more rotameters, integrated with gate valves, solenoid valves and screw valves, to uniformly distribute the electrolyte inside the cells. The rotameters have a capacity of 1-1000 lpm.

According to one embodiment herein, the electrolyte flow management system comprises one or more distributors for a controlled and systematic distribution of electrolyte across the plurality of cells on the same floor as well as on different floors. The uniform distribution of electrolyte helps in maintaining a consistent power output from all the cells in the metal-air battery.

According to one embodiment herein, the electrolyte flow management system comprises a leakage/overflow management system to drain out the spilled electrolyte on each floor.

According to one embodiment herein, a monitoring system comprises one or more feedback sensors to regulate the temperature, flow, power and energy of the overall system. The one or more feedback sensors comprises thermocouples for the temperature measurement, filtration sensor to monitor a need for replacing filters installed for electrolyte purification and a plurality of flowmeters to control the electrolyte flow through the metal-air battery cells present on the one or more floors.

According to one embodiment herein, the monitoring system is provided with a display panel for exhibiting a real time data acquired from the one or more feedback sensors.

According to one embodiment herein, the monitoring system is loaded with an algorithm to accurately estimate a real-time state of charge (SoC) of the auxiliary power sources.

According to one embodiment herein, a hybrid system is provided to store the hydrogen gas produced during the operation of primary metal-air battery.

According to one embodiment herein, the hybrid system comprises a hydrogen fuel cell which runs on the collected hydrogen gas for contributing/enhancing an energy output of the power backup system.

According to one embodiment herein, the power backup system comprises an exhaust setup to remove any type of fumes and gases generated during the operation of the power backup system.

According to one embodiment herein, the one or more auxiliary power sources are charged with the electrical power generated from the GMAB to supply electrical power to a load. The one or more auxiliary power sources are connected to the load through a switching circuit. The output of the auxiliary power source is fed to the load through an inverter. At any time one auxiliary power source is in a charging condition with the electrical power from GMAB, while the other auxiliary power source is in a discharge condition to supply power to the load. the power from the auxiliary power source is fed to domestic electrical appliances that are run on AC through a DC to AC converter.

According to one embodiment herein, one auxiliary power source is selected to supply power to the load, while the other auxiliary power source is charged with the power from GMAB. The state of charge—SoC (which relates to the amount of power left in the battery) is monitored continuously. When the auxiliary power source reaches a pre-set SoC level, the auxiliary power source supplying power to the load is cut off with the help of switching circuit and the second auxiliary power source, under charging condition with the power from GMAB, is switched on to supply electrical power to the load and the first auxiliary source is charged with the power from GMAB.

According to one embodiment herein, the one or more auxiliary power source is selected from a group consisting of metal-ion battery, Ni—Cd battery Li-ion battery, Na-ion battery, K-ion battery, lead acid battery, Ni—Cd battery, supercapacitors, nickel metal hydride battery and redox flow battery.

According to one embodiment herein, the redox flow battery is any one of a vanadium redox battery, zinc-bromine battery, polysulfide-bromide battery etc.

According to one embodiment herein, the power backup system comprises an inverter for converting the generated DC power to AC power to run the electrical appliances. The domestic appliances comprises air conditioner, fridge, television, fan, lights, computers and heavy electrical machinery and equipment used in factories, mines and hospitals.

According to one embodiment herein, the power backup system is configured to deliver power for a short duration of time through the auxiliary power sources without prompting the operation of primary metal-air battery.

According to one embodiment herein, an electronic switching circuit/device is provided to enable switching between the auxiliary power sources.

According to one embodiment herein, only one auxiliary power source is used. The load is directly run with GMAB when only one auxiliary power source is provided in the system. The auxiliary power source is additionally used to meet that power requirement, when the required power is more than that is supplied from GMAB. The additional power than that supplied from GMAB to the load is used to charge the auxiliary power source, when the required power for load is less than the power generated at GMAB.

According to one embodiment herein, a graphene based metal-air battery device, includes: a first layer including an electrolyte reservoir coupled to a heating-cooling system to maintain temperature of an electrolyte; a second layer including a pump for pumping the electrolyte to one or more cells; a filter, coupled to the pump from a first side of the pump, for entrapping aluminum oxide particles generated by electrolyte flow through the cells, and freeing the electrolyte from any metal oxide particle impurities; at least one rotameter coupled to a second side of the pump; at least one electrode including ambient air; at least one settling tank to further remove metal oxide particles from the electrolyte; at least one buffer tank configured to replenish the electrolyte to a desired composition compared to a threshold value; and a mechanical refuelling unit configured for mechanical retraction of consumed aluminum and insertion of a plurality of fresh aluminum cassettes into the cells simultaneously; and a third layer including at least one drain opening for draining out the electrolyte when flowing through the one or more cells.

According to one embodiment herein at any time, during the operation of the power backup system, one or more the auxiliary power sources delivers power to the inverter.

According to one embodiment herein at any time, during the operation of the power backup system, one or more auxiliary power sources get charged by the primary metal-air battery which would later be used for powering the electrical appliances once the discharging auxiliary power source gets discharged to a set SOC.

According to one embodiment herein, the stationary power backup system comprises a housing; a graphene-based metal-air battery disposed in the housing, at least one auxiliary power source disposed in the housing as a secondary and additional back-up. The graphene based metal-air battery comprises an electrolyte reservoir coupled to a Beating-cooling system to maintain a temperature of a stored electrolyte of alkaline in nature; a pump for delivering the electrolyte to a plurality of cells; a filter coupled to a first side of the pump for entrapping aluminum oxide particles generated due to the flow of electrolyte through the cells, and freeing the electrolyte from any metal oxide particle impurities; at least one rotameter coupled to a second side of the pump; at least one electrode and wherein the electrode is an ambient air; at least one settling tank to further remove metal oxide particles from the electrolyte; at least one buffer tank configured to replenish the electrolyte to achieve a desired composition; and a mechanical refuelling unit configured for mechanically extracting the consumed aluminum and inserting a plurality of fresh aluminum cassettes into the cells simultaneously.

According to one embodiment herein, the stationary power backup system further comprises a leakage/overflow management system comprising at least one drain opening connected to a drain pipeline provided in each floor for draining out the electrolyte after passing through the plurality of cells and the electrolyte spilled on the floor. The power back up system further comprises an anode and an air cathode. When the cells are filled with electrolyte, then a metal particle in the anode is converted into a metal oxide and oxygen from the ambient air diffuses through the air cathode and gets reduced to a plurality of OH— ions. Power is generated after the reaction at the anode and the air cathode. The battery is installed on one or more floors. The electrolyte is passed through the at least one cell and drained out through at least one drain opening connected to pipes attached to/mounted on each floor.

According to one embodiment herein, the power back up system further comprises a hydrogen fuel cell, in which hydrogen evolved during a metal-air operation is stored, for hydrogen harvesting. Based on storage, the hydrogen fuel cell uses stored hydrogen for power generation. The one or more cells are arranged on the one or more floors and are connected in series or parallel or in a combination thereof, to act as a combined power source to achieve an optimal combination of energy and power to power the electrical appliances. The one or more floors are arranged in extended/telescopic pattern so that a lower floor has an extended platform which is projected out of the base beyond an upper floor surface level to protect the system from any type of leakage/overflow or spills. The one or more floors are connected to a common drainage system which is further connected to the reservoir.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a perspective view of a hybrid power backup system with a graphene-based metal air battery, according to one embodiment herein.

FIG. 2 illustrates a block diagram of heating-cooling system/mechanism provided in the power backup system, according to one embodiment herein.

FIG. 3 illustrates a block diagram of a charging and discharging circuit for auxiliary power sources provided in the power backup system, when auxiliary power source-1 is in a charging condition, according to one embodiment herein.

FIG. 4 illustrates a block diagram of a charging and discharging circuit for auxiliary power sources provided in the power backup system, when auxiliary power source-2 is in a charging condition, according to one embodiment herein.

FIG. 5 illustrates a flow chart for a method od supplying load through a hybrid power backup using a graphene-based metal air battery, according to one embodiment herein.

FIG. 6 illustrates a block diagram of a switching circuit using single secondary battery, according to one embodiment herein.

FIG. 7 and FIG. 8 jointly illustrate a flow chart of a coulomb counting method to measure the state of charge of auxiliary power sources, according to one embodiment herein.

FIG. 9 illustrates the block diagram of a stationary power backup system, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments herein provide a system architecture for a stationary power backup system using a graphene-based metal-air battery where the power backup system can be used to power domestic electrical appliances & heavy machinery in industries, as power backups in vital services such as hospitals and telecommunication towers and to supply power in remote areas.

The various embodiments herein provide a stationary power backup system comprising a main power source, one or more auxiliary power source, an electrolyte flow management system, electrolyte characteristics management system, a real-time monitoring system, electronic power control system, and Hydrogen Harvesting/Collection System.

According to one embodiment herein, a main power source is graphene-based metal-air battery (GMAB). The main power source in this system generates electrical energy to supply electrical power to the external load. The GMAB comprises a reservoir containing an electrolyte of alkaline nature. The electrolyte is passed through a stack (plurality) of cells that are electrically connected with one another in series or parallel or a combination thereof. Only when the cells are filled with the electrolyte, a reaction is initiated at the anode and the cathode. The metallic particle at the anode is converted into a metal oxide. The oxygen from the ambient air is diffused through the air cathode and is reduced to the OH ions. As a result, an electrical power is generated. The reaction is most efficient, only when the temperature of the electrolyte is with in a pre-set range or threshold level.

According to one embodiment herein, the one or more primary metal-air battery is selected from a group consisting of Aluminium-Air battery, Zinc-Air battery, Lithium-air battery, and Iron-air battery.

According to one embodiment herein, the primary metal-air battery comprises of a plurality of cells and wherein the plurality of cells is in the range of 10-20000.

According to one embodiment herein, the primary metal-air battery cells are arranged in one or more floors (single or multiple floors). The cells on the one or more floors (same or different floors) are electrically connected in series or parallel or a combination thereof.

According to one embodiment herein, an electrolyte characteristic management system is provided to maintain a temperature of the electrolyte within a desired limit or pre-set range or threshold level through a heating-cooling mechanism/system.

According to an embodiment herein, the electrolyte characteristic management system further comprises a plurality of filter cartridges to entrap/capture the aluminum oxide particles that are generated as by-product of the electrolytic reaction with anode and cathode, and are collected from the cells with the electrolyte flow. The filter cartridges are configured to free the electrolyte from any metal oxide particle impurities that interferes in a reaction process with anode and cathode.

According to an embodiment herein, the electrolyte characteristic management system further comprises a plurality of settling tanks for removing metal oxide particles from the electrolyte. According to an embodiment herein, the plurality of settling tanks is a plurality of electrolyte reservoir tanks. The metal oxide particles removed from the electrolyte are made to settle down at the bottom of each tank through gravity forces either naturally or forcefully by chemically induced coagulation process. The coagulation process is performed to increase the size of the particles and to promote a quick/faster settling of metal oxide particles.

According to one embodiment herein, the electrolyte characteristic management system further comprises a plurality of buffer tanks to maintain the electrolyte at desired composition. The electrolyte characteristic management system is configured to regularly monitor the concentrations of all the components present in the electrolyte. The buffer tanks are provided to replenish the electrolyte to the desired composition.

According to one embodiment herein, the electrolyte characteristic management system is configured to maintain an electrolyte temperature in the range of 10-80° C. and also carry out continuous purification of the electrolyte.

According to one embodiment herein, the heating-cooling system comprises one or more combinations of a resistive heater, an inductive heater, a radiator, a fan or coolant circulation system.

According to one embodiment herein, the electrolyte characteristic management system comprises the plurality of filter cartridges selected from a group consisting of a series of screen filters, disc filters, graphene-based filters or plurality of these for the continuous purification of incoming electrolyte by collecting the sludge formed during the operation of metal-air battery.

According to one embodiment herein, a refuelling mechanism is provided to mechanically refuel GMAB. The refuelling mechanism is configured to mechanically retract the consumed aluminum and to insert of a plurality of fresh aluminum cassettes into the cells in a single time.

According to one embodiment herein, an electrolyte flow management system is provided to regulate a circulation of electrolyte through the cells of the primary metal-air battery module.

According to one embodiment herein, the electrolyte flow management system comprises one or more pumps for pumping the electrolyte inside the cells of primary metal-air battery. The one or more pumps is selected from a group consisting of a diaphragm pump, a submersible pump, a centrifugal pump, a positive displacement pump, a hydraulic pump and a combination thereof.

According to one embodiment herein, the electrolyte flow management system comprises one or more rotameters, integrated with gate valves, solenoid valves and screw valves, to uniformly distribute the electrolyte inside the cells. The rotameters have a capacity of 1-1000 lpm.

According to one embodiment herein, the electrolyte flow management system comprises one or more distributors for a controlled and systematic distribution of electrolyte across the plurality of cells on the same floor as well as on different floors. The uniform distribution of electrolyte helps in maintaining a consistent power output from all the cells in the metal-air battery.

According to one embodiment herein, the electrolyte flow management system comprises a leakage/overflow management system to drain out the spilled electrolyte on each floor.

According to one embodiment herein, a monitoring system comprises one or more feedback sensors to regulate the temperature, flow, power and energy of the overall system. The one or more feedback sensors comprises thermocouples for the temperature measurement, filtration sensor to monitor a need for replacing filters installed for electrolyte purification and a plurality of flowmeters to control the electrolyte flow through the metal-air battery cells present on the one or more floors.

According to one embodiment herein, the monitoring system is provided with a display panel for exhibiting a real time data acquired from the one or more feedback sensors.

According to one embodiment herein, the monitoring system is loaded with an algorithm to accurately estimate a real-time state of charge (SoC) of the auxiliary power sources.

According to one embodiment herein, a hybrid system is provided to store the hydrogen gas produced during the operation of primary metal-air battery.

According to one embodiment herein, the hybrid system comprises a hydrogen fuel cell which runs on the collected hydrogen gas for contributing/enhancing an energy output of the power backup system.

According to one embodiment herein, the power backup system comprises an exhaust setup to remove any type of fumes and gases generated during the operation of the power backup system.

According to one embodiment herein, the one or more auxiliary power sources are charged with the electrical power generated from the GMAB to supply electrical power to a load. the one or more auxiliary power sources are connected to the load through a switching circuit. The out put of the auxiliary power source is fed to the load through an inverter. At any time one auxiliary power source is in a charging condition with the electrical power from GMAB, while the other auxiliary power source is in a discharge condition to supply power to the load. the power from the auxiliary power source is fed to domestic electrical appliances that are run on AC through a DC to AC converter.

According to one embodiment herein, one auxiliary power source is selected to supply power to the load, while the other auxiliary power source is charged with the power from GMAB. The state of charge—SoC (which relates to the amount of power left in the battery) is monitored continuously. When the auxiliary power source reaches a pre-set SoC level, the auxiliary power source supplying power to the load is cut off with the help of switching circuit and the second auxiliary power source, under charging condition with the power from GMAB, is switched on to supply electrical power to the load and the first auxiliary source is charged with the power from GMAB.

According to one embodiment herein, the one or more auxiliary power source is selected from a group consisting of metal-ion battery, Ni—Cd battery Li-ion battery, Na-ion battery, K-ion battery, lead acid battery, Ni—Cd battery, supercapacitors, nickel metal hydride battery and redox flow battery,

According to one embodiment herein, the redox flow battery is any one of a vanadium redox battery, zinc-bromine battery, polysulfide-bromide battery etc.

According to one embodiment herein, the power backup system comprises an inverter for converting the generated DC power to AC power to run the electrical appliances. The domestic appliances comprise air conditioner, fridge, television, fan, lights, computers and heavy electrical machinery and equipment used in factories, mines and hospitals.

According to one embodiment herein, the power backup system is configured to deliver power for a short duration of time through the auxiliary power sources without prompting the operation of primary metal-air battery.

According to one embodiment herein, an electronic switching circuit/device is provided to enable switching between the auxiliary power sources.

According to an embodiment herein, a graphene based metal-air battery device, includes: a first layer including an electrolyte reservoir coupled to a heating-cooling system to maintain temperature of an electrolyte; a second layer including a pump for pumping the electrolyte to one or more cells; a filter, coupled to the pump from a first side of the pump, for entrapping aluminum oxide particles generated by electrolyte flow through the cells, and freeing the electrolyte from any metal oxide particle impurities; at least one rotameter coupled to a second side of the pump; at least one electrode including ambient air; at least one settling tank to further remove metal oxide particles from the electrolyte; at least one buffer tank configured to replenish the electrolyte to a desired composition compared to a threshold value; and a mechanical refuelling unit configured for mechanical retraction of consumed aluminum and insertion of a plurality of fresh aluminum cassettes into the cells simultaneously; and a third layer including at least one drain opening for draining out the electrolyte when flowing through the one or more cells.

According to one embodiment herein at any time, during the operation of the power backup system, one or more the auxiliary power sources delivers power to the inverter.

According to one embodiment herein at any time, during the operation of the power backup system, one or more auxiliary power sources get charged by the primary metal-air battery which would later be used for powering the electrical appliances once the discharging auxiliary power source gets discharged to a set SOC.

According to an embodiment herein, the stationary power backup system comprises a housing; a graphene-based metal-air battery disposed in the housing, at least one auxiliary power source disposed in the housing as a secondary and additional back-up. The graphene based metal-air battery comprises an electrolyte reservoir coupled to a heating-cooling system to maintain a temperature of a stored electrolyte of alkaline in nature; a pump for delivering the electrolyte to a plurality of cells; a filter coupled to a first side of the pump for entrapping aluminum oxide particles generated due to the flow of electrolyte through the cells, and freeing the electrolyte from any metal oxide particle impurities; at least one rotameter coupled to a second side of the pump; at least one electrode and wherein the electrode is an ambient air; at least one settling tank to further remove metal oxide particles from the electrolyte; at least one buffer tank configured to replenish the electrolyte to achieve a desired composition; and a mechanical refuelling unit configured for mechanically extracting the consumed aluminum and inserting a plurality of fresh aluminum cassettes into the cells simultaneously.

According to an embodiment herein, the stationary power backup system further comprises a leakage/overflow management system comprising at least one drain opening connected to a drain pipeline provided in each floor for draining out the electrolyte after passing through the plurality of cells and the electrolyte spilled on the floor. The power back up system further comprises an anode and an air cathode. When the cells are filled with electrolyte, then a metal particle in the anode is converted into a metal oxide and oxygen from the ambient air diffuses through the air cathode and gets reduced to a plurality of OH— ions. Power is generated after the reaction at the anode and the air cathode. The battery is installed on one or more floors. The electrolyte is passed through the at least one cell and drained out through at least one drain opening connected to pipes attached to/mounted on each floor.

According to an embodiment herein, the power back up system further comprises a hydrogen fuel cell, in which hydrogen evolved during a metal-air operation is stored, for hydrogen harvesting. Based on storage, the hydrogen fuel cell uses stored hydrogen for power generation. The one or more cells are arranged on the one or more floors and are connected in series or parallel or in a combination thereof, to act as a combined power source to achieve an optimal combination of energy and power to power the electrical appliances. The one or more floors are arranged in extended/telescopic pattern so that a lower floor has an extended platform which is projected out of the base beyond an upper floor surface level to protect the system from any type of leakage/overflow or spills. The one or more floors are connected to a common drainage system which is further connected to the reservoir.

According to one embodiment herein, a method of supplying power to a load through a power backup system comprises mounting a graphene based metal-air battery system in a housing: connecting an electrolyte reservoir to a heating-cooling system to maintain temperature of an electrolyte; pumping, by a pump, the electrolyte to one or more cells; connecting a filter to the pump from a first side of the pump for, entrapping aluminum oxide particles generated by electrolyte flow through the cells, and freeing the electrolyte from any metal oxide particle impurities; connecting at least one rotameter to a second side of the pump; storing ambient air in at least one electrode; settling, by at least one settling tank, to further remove metal oxide particles from the electrolyte; replenishing, by at least one buffer tank, the electrolyte to a desired composition compared to a threshold value; retracting mechanically, by a mechanical refuelling unit, consumed aluminum and inserting a plurality of fresh aluminum cassettes into the cells simultaneously: and draining, by at least one drain opening, out the electrolyte when flowing through the one or more cells.

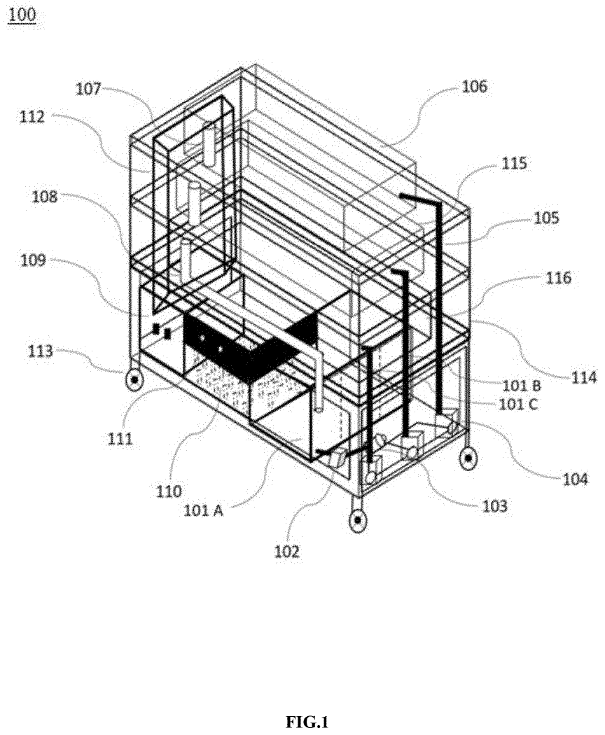

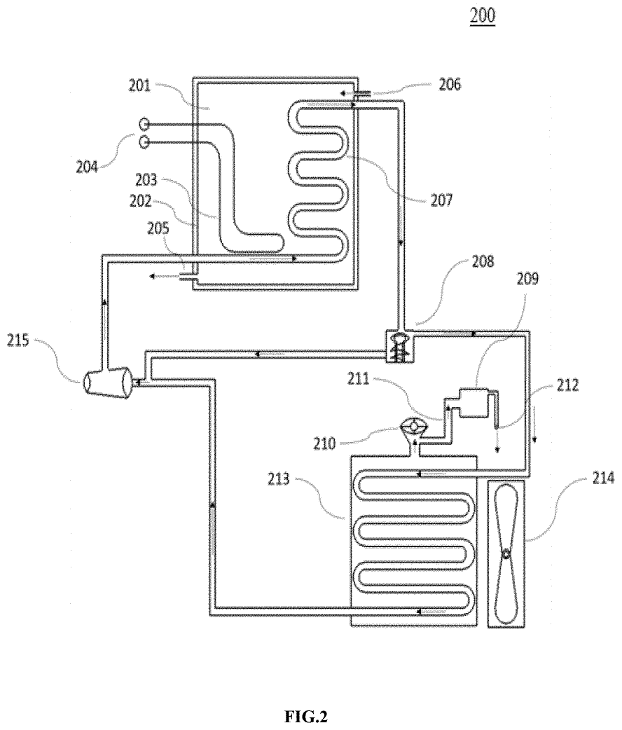

FIG. 1 illustrates a schematic representation of hybrid power backup system using a graphene-based metal air battery. With respect to FIG. 1, electrolyte reservoir 101 A is provided with a settling tank 101B for removing metal oxide particles from the electrolyte, a buffer tank 101C to maintain electrolyte concentration at pre-set level, and a heating-cooling system (shown in FIG. 2) to maintain the temperature of the electrolyte. The electrolyte is pumped to the cell with the help of a pump, 103, and the pump is connected to a filter from one side and other side is connected to one or multiple rotameters, 104. According to the figure, the installed hybrid system is represented by 112; here, hydrogen evolved during metal air operation is stored and later used for power generation through hydrogen fuel cell. Once the electrolyte flows through the cells it drains out from drain opening, 107, through pipes attached to each floor. The multiple floors in the hybrid power backup are represented by 116 and 105 where individual battery cells are arranged in series or parallel or in a combination thereof. In addition, the floors 106 and 115 are arranged in extending pattern so that lower floor, 115, has extended platform than that of its upper floor, 106, extending from the base protects the system from any type of leakage/overflow or spills. All the floors are connected further to a common drainage system, 108, which is connected to reservoir 101. The stationary support structure, 114, comprises of multiple compartments at the base of the structure on which an inverter, 109, circuit system designed for the embodiments herein, 111, and a compartment of auxiliary power sources, 110, are placed. The support structure is integrated with wheels, 113, which makes the system easy to displace from one place to another.

FIG. 2 illustrates a block diagram of heating-cooling system/mechanism provided in the power backup system, according to one embodiment herein, to maintain the temperature of the electrolyte within a desired range. According to the figure a reservoir for the electrolyte is indicated by 201, which is insulated by a thermal insulation layer, 202. A heating coil/heater, 203, is integrated with the reservoir which helps in heating up the electrolyte to an optimum temperature where graphene-based metal air battery works most efficiently; electrical terminals of the heating coil/heater is represented by 204. In the figure, the outlet channel for electrolyte flow from reservoir to the primary metal-air battery is given by 205; the inlet channel from where electrolyte coming from primary metal-air battery enters the reservoir is indicated by 206. A cooling coil, 207, is attached with the reservoir to cool down the electrolyte and a thermostat valve, 208, is installed to allows coolant to flow through it only when the temperature crosses a threshold value. A tank for the storage of coolant is given by 209 whereas the radiator cap is shown by 210. The expansion bleed pipe and the overflow drainpipe are represented by 211 and 212 respectively. A condenser, 213, is connected to a fan, 214. Lastly, the pump for the circulation of coolant is through the system is indicated by 215.

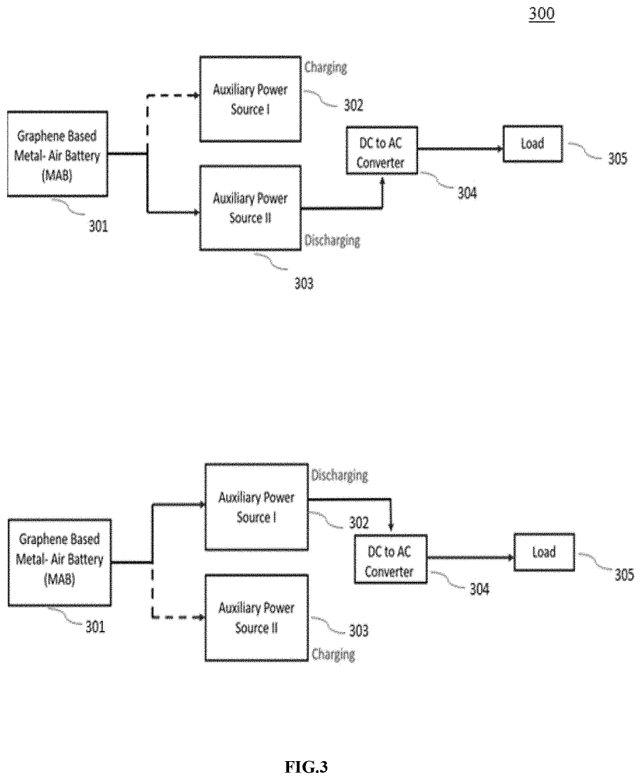

FIG. 3 illustrates a block diagram of a charging and discharging circuit for auxiliary power sources provided in the power backup system, when auxiliary power source-1 is in a charging condition, according to one embodiment herein. With respect to FIG. 3, at any time, power from GMAB 301 is used to charge at least one auxiliary power source 302, 303 while the other auxiliary power source/s 302, 303 provides power to the load 305 (since power from batteries is in DC form so we have DC to AC converter 304 for appliances which generally runs on AC power). The state of charge—SOC (which relates to the amount of power left in the battery) in monitored continuously and when the auxiliary power source 302 reaches a particular SOC it is cut off with the help of switching circuit and the second auxiliary power source 303, which was getting charged from GMAB 301, provides power to the load 305 while GMAB 301 charges the first auxiliary power source 302 which got discharged. This cycle goes on until the whole system 300 and 100 of FIG. 1 is turned off.

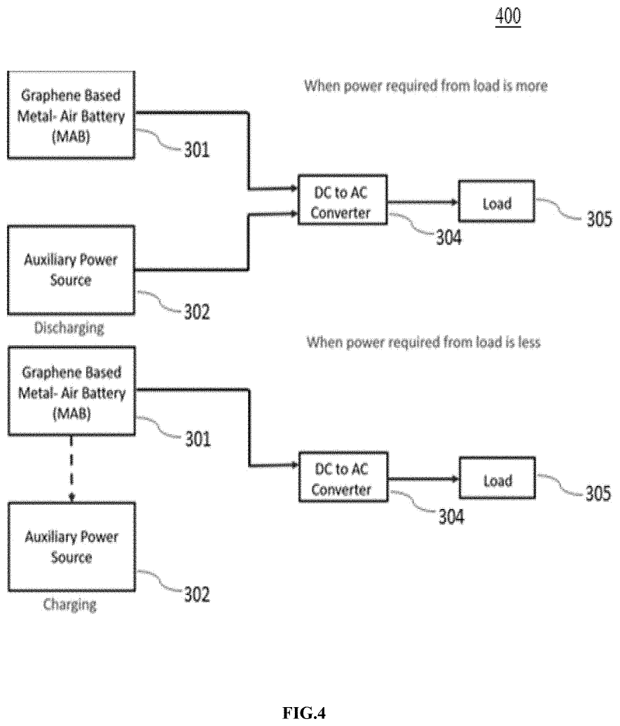

FIG. 4 illustrates a block diagram of a charging and discharging circuit for auxiliary power sources provided in the power backup system, when auxiliary power source-2 is in a charging condition, according to one embodiment herein. With respect to FIG. 4 a system 400 is provided with only one auxiliary power source 302, such that with only one auxiliary power source 302 the load 305 will be directly run with GMAB 301. When the required power is more than what GMAB 301 may provide, the auxiliary power source 302 kicks in to meet that power requirement. When the load 305 is less the extra power from GMAB 301 goes to charge the auxiliary power source 302.

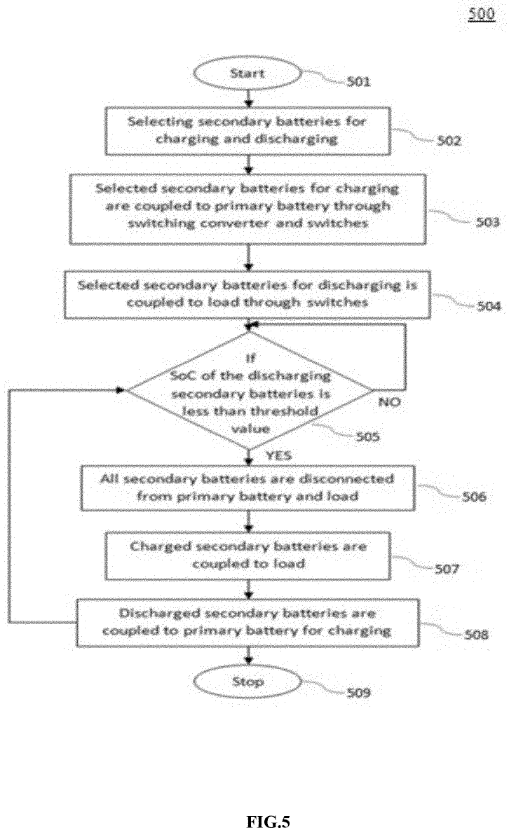

FIG. 5 illustrates a flow chart for a method of supplying load through a hybrid power backup using a graphene-based metal air battery, according to one embodiment herein. With respect to FIG. 5, the method starts at a step 501. At a second step 502, secondary batteries are selected for charging and discharging. At a step 503, selected secondary batteries for charging are coupled to primary battery through switching converter and switches. At a step 504, selected secondary batteries for discharging is coupled to load through switches. At step 505, a comparison is done, that is if SOC of the discharging secondary batteries is less than threshold value. If the option is yes then the control proceeds to step 506, however, if the option is no, then the control goes back to comparison of step 505. At a step 506, all secondary batteries are disconnected from primary battery and load. At a step 507, charged secondary batteries are coupled to the load. At a step 508, discharged secondary batteries are coupled to primary battery for charging. At a step 509, the method terminates.

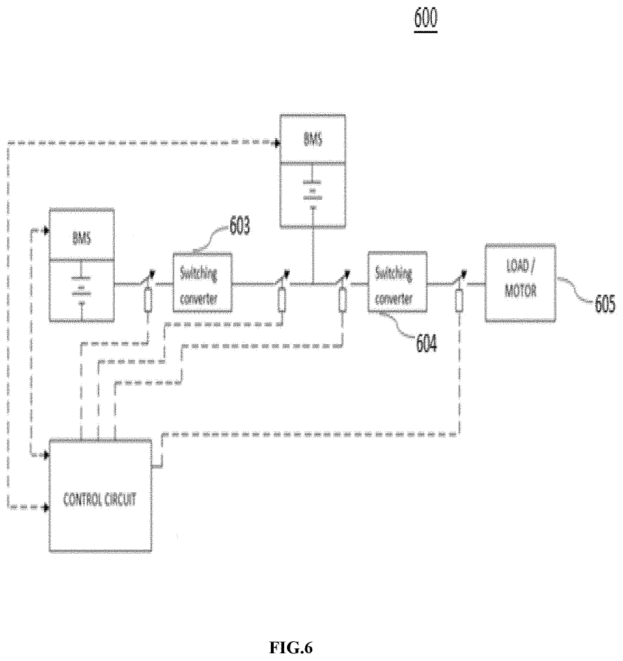

FIG. 6 illustrates a block diagram of a switching circuit using single secondary battery, according to one embodiment herein. With respect to FIG. 6 a switching circuit 600 for single secondary battery is provided. In this system 600 a primary battery, a secondary battery and a load 605 is connected in parallel to operated together. All the switches 603, 604 in the system are enabled. The unregulated voltage of primary battery is regulated by first set of switching converter 603 to charge the secondary battery. The voltage at the secondary battery terminal various with the state of charge (SOC) of the secondary battery. To provide a constant/regulated voltage at load terminal the second switching converter 604 is used this will stabilize the voltage at the load terminal 605.

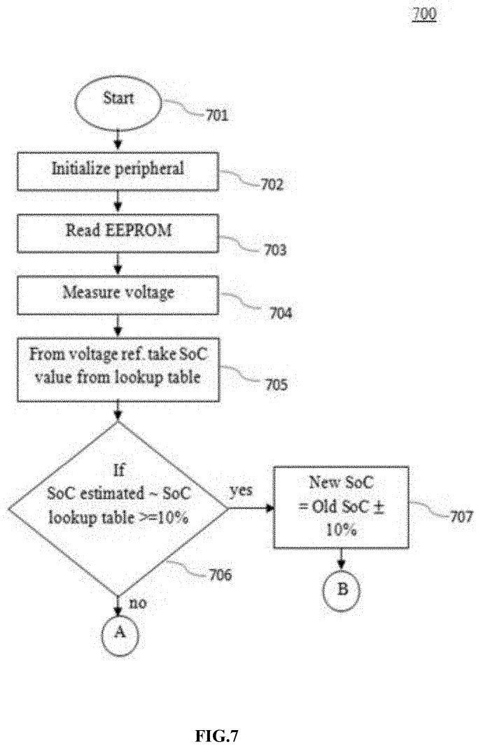

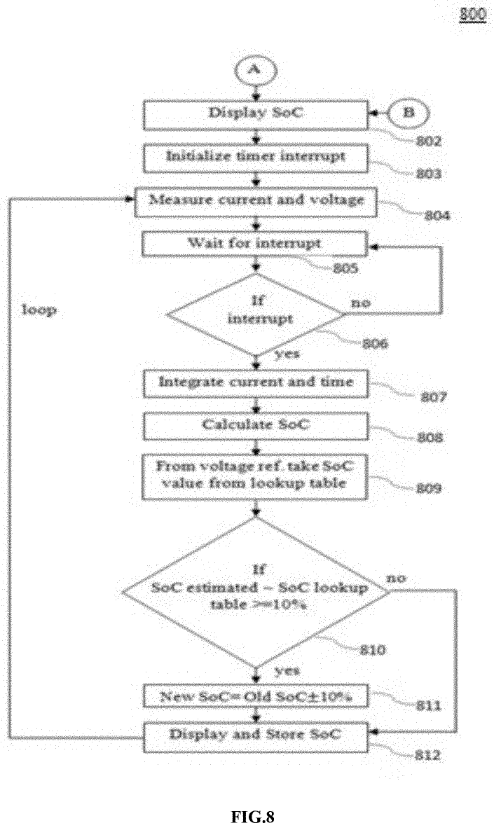

FIG. 7 and FIG. 8 jointly illustrate a flow chart of a coulomb counting method to measure the state of charge of auxiliary power sources, according to one embodiment herein. The method starts at a step 701. At a step 702, a peripheral, that is the electronic device including a graphene-based metal-air battery, is initialized. At a step 703, an EEPROM connected to the metal-air battery is read. At a step 704, a battery voltage is measured. At a step 705, from the voltage reference SOC value is taken from a look up table of the EEPROM. At a step 706, a comparison is done, that is if SOC estimated that is equivalent to SOC of look up table is greater than or equal to 10%. If the option is yes then control is transferred to a step 707, however, if the option is no then the control is transferred to a connector A of FIG. 8. At the step 707, a new SOC is assigned to an old SOC with a tolerance value of 10%. A second step 802 consists of displaying the SOC after the connector A transfers control to the step 802. A third step 803 begins at the connector B where the control is transferred by the connector B to the step 802. A fourth step 804 starts by initializing a timer interrupt. At a fifth step 805, current and voltage of the electronic device/battery of FIG. 1 is measured. At a sixth step 806, the electronic device/battery waits for interrupt. At a seventh step 807, a comparison is done, that is, if the interrupt is valid. If the option is yes, then control transfers to a step 808. If the option is yes, then control transfers to the step 806. At the step 808, current and time are integrated. At a step 809, SOC is calculated. At a step 810, from voltage reference, SOC value is taken from the look up table of the EEPROM. At a step 811, a comparison is done, that is, if SOC estimated that is equivalent to SOC of look up table is greater than or equal to 10%. If the option is yes, then the control is transferred to a step 812. If the option is no, then the control is transferred to a step 813. At the step 812, a new SOC is assigned to an old SOC with a tolerance value of 10%. At the step 813, the SOC is displayed and stored.

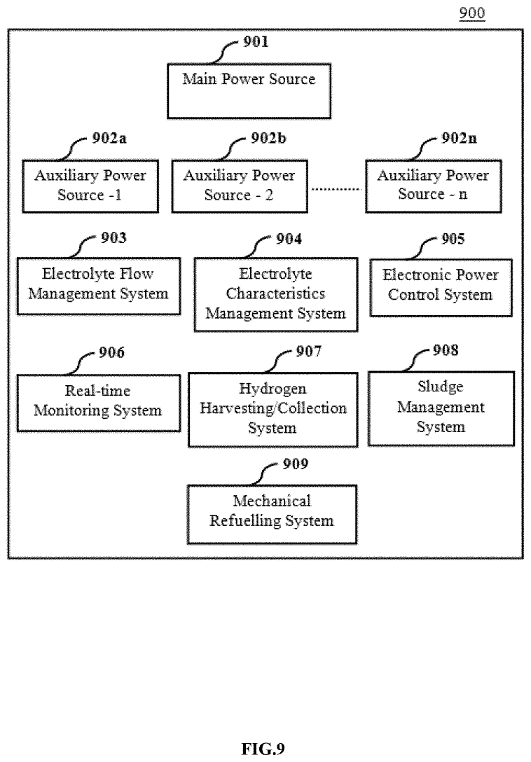

FIG. 9 illustrates the block diagram of a stationary power backup system. The system comprises a main power source 901, a plurality of auxiliary power sources 902a, 902b, . . . . 902n, an electrolyte flow management system 903, electrolyte characteristics management system 904, a real-time monitoring system 905, electronic power control system 906, Hydrogen Harvesting/Collection System 907, Sludge Management System 908 and Mechanical Refuelling System 909.

The embodiments herein provide a system architecture for a hybrid power backup using graphene-based metal-air battery, acting as the primary power source, where the primary metal-air battery are any one of Aluminum-Air battery, Zinc-Air battery, Lithium-air battery, iron-air battery.

The embodiments herein provides a system architecture for a hybrid power backup using graphene-based metal-air battery which can be used to power domestic electrical appliances & heavy machinery in industries, as power backups in vital services such as hospitals & telecommunication towers and to supply power in remote areas.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A stationary power backup system comprising;
a main power source, and wherein the main power source comprises a primary metal air battery, and wherein the primary metal air battery is a graphene-based metal-air battery (GMAB) for generating electrical power;
one or more auxiliary power source connected to the main power source for receiving and storing the generated electrical power for supplying to a load;
an electrolyte flow management system to regulate a circulation of electrolyte through the cells of the primary metal-air battery module;
an electrolyte characteristics management system to maintain a temperature of the electrolyte within a desired limit or pre-set range or threshold level through a heating-cooling mechanism/system;
a real-time monitoring and feedback system to regulate the temperature, flow, power and energy of the overall system;
electronic power control system comprising a switching circuit, DC-AC inverter, DC-DC converter, and DC-DC charger; and
Hydrogen Harvesting/Collection System to store the hydrogen gas produced during the operation of primary metal-air battery;
wherein the one or more auxiliary power sources are charged with the electrical power generated from the GMAB to supply electrical power to a load and wherein the one or more auxiliary power sources are connected to the load through the switching circuit, and wherein the output of the auxiliary power source is fed to the load through an inverter, and wherein one auxiliary power source is in a charging condition with the electrical power from GMAB, while the other auxiliary power source is in a discharge condition to supply power to the load at any instant, and wherein a state of charge—SoC (which relates to the amount of power left in the battery) is monitored continuously, and wherein the auxiliary power source supplying power to the load is cut off with the help of switching circuit, and the second auxiliary power source, under charging condition with the power from GMAB, is switched on to supply electrical power to the load and the first auxiliary source is charged with the power from GMAB, when the auxiliary power source reaches a pre-set SoC level.

2. The system according to claim 1, wherein the GMAB comprises a plurality of cells and a reservoir containing an electrolyte, and wherein the electrolyte is passed through a plurality of cells that are electrically connected with one another in series or parallel or a combination thereof, and wherein the cells are filled with the electrolyte, and wherein the plurality of cells are configured to generate a power based on a reaction initiated at the anode and the cathode after the filling of the electrolyte in the plurality of cells; and wherein the metal at the anode is converted into a metal oxide and the oxygen from the ambient air is diffused through the air cathode to get reduced to the OH⁻ ions, thereby generating an electrical power, and, wherein the primary metal-air battery is selected from a group consisting of Aluminium-Air battery, Zinc-Air battery, Lithium-air battery, and Iron-air battery, and wherein the plurality of cells is in the range of 10-20000.

3. The system according to claim 1, wherein the plurality of cells is arranged in one or more floors, and wherein the plurality of cells on the one or more floors are electrically connected in series or parallel or a combination thereof.

4. The system according to claim 1, wherein the electrolyte characteristic management system further comprises a plurality of filter cartridges to entrap/capture the metal oxide particles that are generated as by-product of the electrolytic reaction with anode and cathode, and are collected from the cells with the electrolyte flow, and wherein the filter cartridges are configured to free the electrolyte from any metal oxide particle impurities that interferes in a reaction process with anode and cathode.

5. The system according to claim 1, wherein the electrolyte characteristic management system further comprises a plurality of settling tanks for removing metal oxide particles from the electrolyte, and wherein the plurality of settling tanks is a plurality of electrolyte reservoir tanks configured for receiving the metal oxide particles removed from the electrolyte to settle down at the bottom of each tank through gravity forces either naturally or forcefully by chemically induced coagulation or flocculation process, and wherein the coagulation or flocculation process are performed to increase the size of the particles and to promote a quick/faster settling of metal oxide particles.

6. The system according to claim 1, wherein the electrolyte characteristic management system further comprises a plurality of buffer tanks to maintain the electrolyte at desired composition, and wherein the electrolyte characteristic management system is configured to regularly monitor the concentrations of all the components present in the electrolyte, and wherein the buffer tanks are provided to replenish the electrolyte to the desired composition.

7. The system according to claim 1, wherein the electrolyte characteristic management system is configured to maintain an electrolyte temperature in the range of 10-80° C. and also carry out continuous purification of the electrolyte.

8. The system according to claim 1, wherein the heating-cooling system comprises one or more combinations of a resistive heater, an inductive heater, a radiator, a fan or coolant circulation system.

9. The system according to claim 1, wherein the electrolyte characteristic management system comprises the plurality of filter cartridges selected from a group consisting of a series of screen filters, disc filters, graphene-based filters or plurality of these for the continuous purification of incoming electrolyte by collecting the sludge formed during the operation of metal-air battery.

10. The system according to claim 1, wherein a refuelling mechanism is provided to mechanically refuel GMAB, and wherein the refuelling mechanism is configured to mechanically retract the consumed metal and to insert of a plurality of fresh metal cassettes into the cells in a single time.

11. The system according to claim 1, wherein the electrolyte flow management system comprises one or more pumps for pumping the electrolyte inside the cells of primary metal-air battery, and wherein the one or more pumps is selected from a group consisting of a diaphragm pump, a submersible pump, a centrifugal pump, a positive displacement pump, a hydraulic pump and a combination thereof.

12. The system according to claim 1, wherein the electrolyte flow management system further comprises one or more rotameters, integrated with gate valves, solenoid valves and screw valves, to uniformly distribute the electrolyte inside the cells, and wherein the rotameters have a capacity of 1-1000 lpm.

13. The system according to claim 1, wherein the electrolyte flow management system comprises one or more distributors for a controlled and systematic distribution of electrolyte across the plurality of cells on the same floor as well as on different floors to maintain a consistent power output from all the cells in the metal-air battery.

14. The system according to claim 1, wherein the electrolyte flow management system comprises a leakage/overflow management system to drain out the spilled electrolyte on each floor, and wherein the leakage/overflow management system comprises a drain opening connected to a drainpipe arranged in each floor.

15. The system according to claim 1, wherein the real time monitoring system comprises one or more feedback sensors to regulate the temperature, flow, power and energy of the overall system, and wherein the one or more feedback sensors comprises thermocouples for the temperature measurement, filtration sensor to monitor a need for replacing filters installed for electrolyte purification and a plurality of flow meters to control the electrolyte flow through the metal-air battery cells present on the one or more floors, and wherein the real-time monitoring system is provided with a display panel for exhibiting a real time data acquired from the one or more feedback sensors, and wherein the real-time monitoring system is loaded with an algorithm to accurately estimate a real-time state of charge (SoC) of the auxiliary power sources

16. The system according to claim 1, wherein the hybrid system comprises a hydrogen fuel cell which runs on the collected hydrogen gas for contributing/enhancing an energy output of the power backup system.

17. The system according to claim 1, wherein the power backup system comprises an exhaust setup to remove any type of fumes and gases generated during the operation of the power backup system.

18. The system according to claim 1, wherein the one or more auxiliary power source is selected from a group consisting of metal-ion battery, Ni—Cd battery Li-ion battery, Na-ion battery, K-ion battery, lead acid battery, Ni—Cd battery, supercapacitors, nickel metal hydride battery and redox flow battery, and wherein the redox flow battery is any one of a vanadium redox battery, zinc-bromine battery, polysulfide-bromide battery.

19. The system according to claim 1, wherein the reservoir is insulated by a thermal insulation layer, and wherein a heating coil is integrated with the reservoir to heat up the electrolyte to an optimum temperature, and wherein a cooling coil is attached with the reservoir to cool down the electrolyte.

20. The system according to claim 1, wherein only one auxiliary power source is provided, and wherein the load is directly run with GMAB, when only one auxiliary power source is used, and wherein the auxiliary power source is additionally used to meet that power requirement, when the required power is more than that is supplied from GMAB, and wherein the additional power than that supplied from GMAB to the load is used to charge the auxiliary power source, when the required power for load is less than the power generated at GMAB.
